(19) United States
(12) Patent Application Publication
(10) Pub. No.: US 2026/0212784 A1
(43) Pub. Date: Jul. 23, 2026

(54) MEDICAL DEVICE SIMULATOR

(71) Applicant: Stryker Corporation, Portage, MI (US)

(72) Inventors: Michelle Liu, Redmond, WA (US); David B. Stewart, Carnation, WA (US)

(73) Assignee: Stryker Corporation, Portage, MI (US)

(21) Appl. No.: 19/452,056

(22) Filed: Jan. 16, 2026

Related U.S. Application Data
(60) Provisional application No. 63/746,885, filed on Jan. 17, 2025.

(51) Int. Cl. G09B 23/28

(52) U.S. Cl. CPC G09B 23/288

(57) ABSTRACT

An example method performed by a computing device includes receiving patient data indicating physiological parameters of a subject during a rescue event; generating simulated patient data by altering the patient data; and generating a simulated medical device user interface (UI) indicating the simulated patient data. The example method further includes receiving an input signal from a user and displaying the simulated medical device UI by displaying a first segment of the simulated patient data indicating a medical condition that is responsive to a treatment; and displaying a recommendation to administer the treatment. In response to displaying the recommendation to administer the treatment and in response receiving the input signal, the example method includes displaying a second segment of the simulated patient data indicating a simulated response to the treatment.

### CROSS-REFERENCE TO RELATED APPLICATION

This application claims priority to U.S. Provisional App. No. 63/746,885, which was filed on Jan. 17, 2025 and is incorporated by reference herein in its entirety.

### BACKGROUND

Medical devices provide valuable assistance to care providers monitoring and treating subjects, such as patients. Various medical devices are capable of detecting physiological parameters that cannot be ascertained by care providers directly. Moreover, some medical devices notify care providers of sudden changes to physiological parameters, or circumstances in which subjects are in need of urgent medical attention. Some medical devices, such as defibrillators, are configured to administer treatments to subjects in need thereof. To safely and adequately utilize the complex functions of medical devices, care providers engage in training to operate the medical devices prior to utilization.

### BRIEF DESCRIPTION OF THE DRAWINGS

FIG. 1 illustrates an example environment for simulating a user interface associated with operating a medical device during a rescue event.

FIG. 2 illustrates example signaling associated with a data modifier.

FIG. 3 illustrates example signaling associated with a treatment simulator.

FIG. 4 illustrates example signaling associated with an artifact simulator.

FIG. 5 illustrates example signaling or updating the user interface of a medical device based on a simulation of the user interface on a non-medical device.

FIG. 6 illustrates an example process for simulating a user interface on a non-medical device.

FIG. 7 illustrates an example of an external defibrillator associated with various functions described herein.

### DETAILED DESCRIPTION

Various implementations described herein relate to techniques for simulating a medical device user interface (UI) on a non-medical device. Techniques described herein can accurately simulate the operation of the medical device for a user in the event of a medical emergency. In some cases, data reflecting the status of a patient experiencing a medical emergency can be conveyed to a user in the simulation. In some examples, the data is simulated based on one or more instances of real-world medical emergencies. However, in some implementations, the simulated data is distinct from a real-world medical emergency. This can prevent the exposure of private medical data during the simulation. In some cases, treatment responses and/or artifact can be further simulated, which can increase the quality of the simulation for the user. Accordingly, in various implementations, the simulated user interface can provide high-quality training to the user, even before the user handles the medical device itself.

Implementations of the present disclosure provide various improvements to the technical field of medical device simulation and training. In some cases, a medical device can be simulated by initiating a playback of various physiological parameters detected by a real medical device during a real-world rescue event. However, such playback simulations are unable to simulate the response of a patient to the administration of treatments, or the injection of artifact, at the discretion of the user engaging with the simulation. For instance, the playback simulation may illustrate the patient's response to a treatment administered during the real-world medical event, but does not enable the user to see the response of administering the treatment at a different time within the rescue event, or using alternative treatment parameters. In various implementations of the present disclosure, treatment responses can be simulated on-demand, which enables the simulated user interface to dynamically respond to selections by the user during the simulation itself. This can improve the quality of training that the user receives due to the simulation.

Various implementations of the present disclosure will now be described with reference to the accompanying figures.

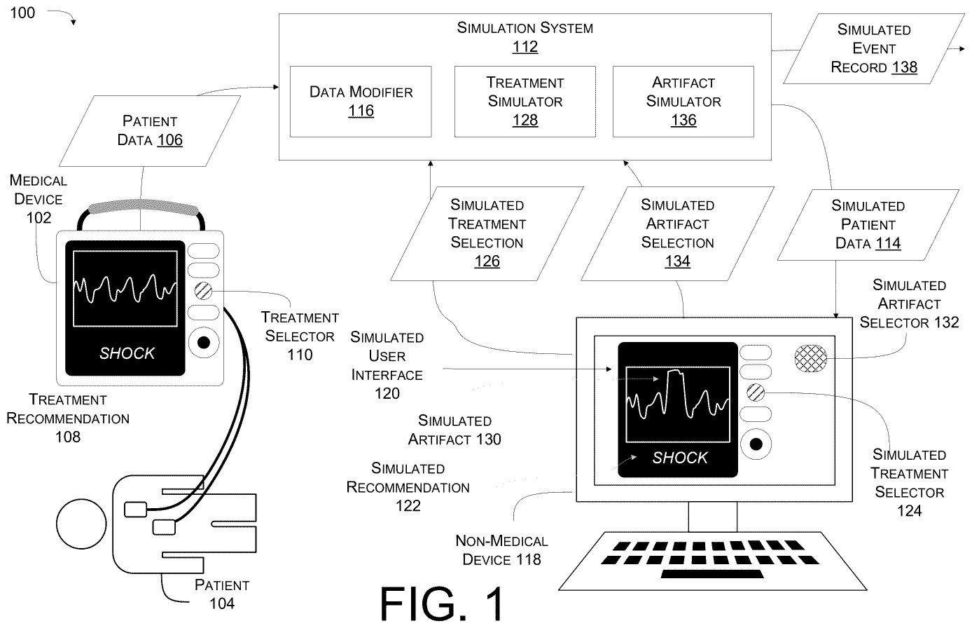

FIG. 1 illustrates an example environment 100 for simulating a user interface associated with operating a medical device 102 during a rescue event. In various cases, the medical device 102 is configured to monitor and/or treat patients during various emergencies, such as the patient 104 during a particular instance of a medical emergency.

In various examples, the medical device 102 is configured to generate patient data 106 by detecting one or more physiological parameters of the patient 104 during the rescue event. The term “physiological parameter,” and its equivalents, may refer to a measurable metric that is indicative of a medical condition of a subject. Examples of physiological parameters include an electrocardiogram (ECG), an electrical impedance (e.g., a transthoracic impedance), airway parameters (e.g., a partial pressure of carbon dioxide (CO₂) or oxygen (O₂) in the airway of a subject, a flow rate of air in the airway, a pressure in the airway, a respiration rate, a ventilation rate, capnograph, end-tidal CO₂ (EtCO₂), etc.), a blood flow parameter (e.g., a velocity of blood in at least one blood vessel, a volumetric flow rate of blood, a pulse wave velocity, pulse rate, etc.), a blood pressure (e.g., a diastolic blood pressure, a systolic blood pressure, an instantaneous blood pressure in at least one blood vessel, etc.), a blood oxygenation (e.g., pulse oxygenation (SpO₂), regional oxygenation, cerebral oxygenation, plethysmograph, etc.), a heart rate, a temperature, an acceleration, or metrics derived from any combination of aforementioned parameters. In various cases, the medical device 102 includes, or is communicatively coupled with, one or more physiological sensors configured to detect the physiological parameter(s). Examples of physiological sensors include electrodes, a gas sensor, a pressure sensor, a blood flow sensor (e.g., an ultrasound transducer configured to detect blood velocity using Doppler-based techniques), a blood pressure cuff, an invasive blood pressure sensor, a blood oxygenation sensor, a light sensor, a thermometer, an accelerometer, or any combination thereof. In some cases, the patient data 106 includes data indicative of repeated samples of the physiological parameter(s) with respect to time. In cases in which the medical device 102 samples multiple physiological parameters, the physiological parameters may be sampled at different sampling rates.

In some examples, the patient data 106 further includes additional data indicative of interactions between the medical device 102 and a user of the medical device. For instance, in various cases, the medical device 102 is configured to generate a treatment recommendation 108 based on an analysis of the physiological parameter(s). The treatment recommendation 108, for instance, may indicate that the medical device 102 has predicted that the patient 104 has a medical condition that can be addressed by a medical treatment. In some cases, the treatment recommendation 108 instructs the user to apply the treatment to the patient 104 and/or how to apply the treatment to the patient 104. In particular examples, the medical device 102 is configured to detect the presence of an arrhythmia that is treatable by a form of electrotherapy in an ECG of the patient 104. For instance, the medical device 102 determine that the ECG of the patient 104 is indicative of ventricular fibrillation (VF), which is treatable by defibrillation. In these examples, the medical device 102 may be configured to generate the treatment recommendation 108 that instructs the user to administer an electrical shock to the patient 104 in view of the identified arrhythmia. In some examples, the patient data 106 includes data indicating a time at which the treatment recommendation 108 was output to the user and/or content of the treatment recommendation 108.

In some examples, the medical device 102 is configured to administer the treatment to the patient 104. For example, the medical device 102 includes a treatment selector 110. When the medical device 102 detects an input signal from the user via the treatment selector 110, then the medical device 102 may output the treatment to the patient 104. In particular cases, the treatment is an electrotherapy treatment. For example, the medical device 102 may be configured to administer an electrical shock to the patient 104 in response to the treatment selector 110 receiving the input signal from the user.

In various cases, the patient data 106 further indicates data indicating that a treatment was administered to the patient 104. For example, if the medical device 102 detected the input signal via the treatment selector 110, and administered the treatment to the patient 104, then the patient data 106 may further include data indicating the treatment administered to the patient 104. For instance, the patient data 106 may include data indicating a time at which the treatment selector 110 was selected by the user, one or more parameters of the treatment (e.g., an energy level, a frequency, etc.), a time at which the treatment was output to the patient 104, or any combination thereof.

In some examples the patient data 106 includes identifying data that identify the rescue event, the patient 104, the user of the medical device 102 during the rescue event, or a combination thereof. For example, the identifying data, in some cases, indicates a location at which the medical device 102 monitored and/or treated the patient 104. In some aspects, the identifying data includes a time at which the medical device 102 monitored and/or treated the patient 104. In some cases, the identifying data includes information identifying the patient 104 (e.g., name, demographics, or other identifiers), information identifying the user of the medical device 102 (e.g., employee identifier, name, demographics, or other identifiers), or a combination thereof.

The medical device 102 includes various input devices and output devices configured to guide the user. Examples of user input devices configured to detect signals from the user, for instance, include the treatment selector 110, buttons, touch sensors, microphones, dials, accelerometers, or any combination thereof. Examples of user output devices configured to output signals to the user, for instance, include displays (e.g., a screen that displays the treatment recommendation 108), speakers, vibrating elements (e.g., to provide haptic feedback), lights, printers, or any combination thereof. In various implementations, user input devices can be integrated with user output devices. For instance, the medical device 102 may have a touchscreen including a display screen integrated with an array of touch sensors.

In various cases, the medical device 102 further includes one or more processors. The software executed by the processor(s) that enables the medical device 102 to perform various functions described herein, including functions related to signals detected by the user input devices and/or output by the user output devices. For example, the medical device 102 executes an operating system that, when executed by the processor(s) of the medical device 102, causes the medical device 102 to manage software (e.g., application) and hardware resources (e.g., processing resources, memory resources, etc.) of the medical device 102. In various cases, the medical device 102 executes one or more applications that cause the medical device 102 to perform various functions, such as the analysis functions and output functions described herein. One example of an application, for instance, includes an application that enables the medical device 102 to determine whether the physiological parameter(s) of the patient 104 are indicative of an arrhythmia. In some examples, the medical device 102 further includes one or more drivers that enables the operating system of the medical device 102 to control the output devices and to translate signals detected by the input devices (e.g., the physiological sensors and the user input devices). For example, the treatment selector 110 may be a physical button configured to detect a press signal by a user, and a driver within the medical device 102 may be configured to translate the press signal detected by the treatment selector 110 into digital data that can be analyzed by the one or more applications executed by the medical device 102.

Collectively, the hardware and software resources of the medical device 102 that enable the medical device 102 to interact with the user can be referred to as the “user interface” or “UI” of the medical device 102. For example, the UI of the medical device 102 includes the graphics visually presented on the screen of the medical device 102, which includes the treatment recommendation 108 as well as one or more indicators (e.g., numerical indicators, waveforms, or other graphics) representing the physiological parameter(s) of the patient 104. In various cases, the UI of the medical device 102 includes the treatment selector 110. The UI of the medical device 102, in some cases, includes the user input devices, the user output devices, the signals presented by the user output devices, or any combination thereof.

It may be beneficial to train the user on how to operate the medical device 102 prior to the user operating the medical device 102 in a real-world rescue scene. Without prior training, the user may be unable to utilize important functions of the medical device 102 for monitoring and treating the patient 104. In some cases, without prior training, the user may misuse the medical device 102. For various reasons, operation of the medical device 102 without prior training can lead to adverse health outcomes for the patient 104, particularly in medical emergencies.

In various implementations of the present disclosure, a simulation system 112 is configured to simulate the operation of the UI of the medical device 102 during a simulated rescue event for training purposes. In various cases, the simulated rescue event is modeled based on prior patient data, rather than reflective of a real-time rescue event. Accordingly, the simulation system 112 is configured to provide an untrained user with the opportunity to learn to use the medical device 102 without harming real-world patients, such as the patient 104.

The simulation system 112 is configured to receive the patient data 106 from the medical device 102. In various cases, the simulation system 112 generates simulated patient data 114 based, at least in part, on the patient data 106. Because the patient data 106 is reflective of a real-world rescue event involving care and management of the patient 104, the simulated patient data 114 is therefore based on a real-world instance of operation of the medical device 102.

The simulated patient data 114 is modified with respect to the patient data 106. In some cases, the modifications of the patient data 106 can facilitate compliance with one or more privacy laws that apply to the jurisdiction in which the medical device 102 and/or simulation system 112 operate. For example, legal rules designed to protect the privacy rights of the patient 104 may prohibit playing back the patient data 106 to trainees.

In various implementations, the simulation system 112 includes a data modifier 116 configured to modify the patient data 106 to generate the simulated patient data 114. In various cases, the data modifier 116 deidentifies the patient data 106 by discarding the identifying data in the patient data 106. For example, the data modifier 116 ensures that any identifying data within the patient data 106 is omitted from the simulated patient data 114. In some cases, the data modifier 116 alters data representing the physiological parameter(s) of the patient 104. In some cases, the data modifier 116 modifies the timing and/or amplitude of the physiological parameter(s) in the simulated patient data 114, without altering the condition represented by the physiological parameter(s). For instance, in some cases, the data modifier 116 generates the simulated patient data 114 by changing a frequency of a VF arrhythmia reflected in the ECG indicated in the patient data 106, however both the patient data 106 and the simulated patient data 114 include a VF-indicating ECG data. In some implementations, the data modifier 116 combines the patient data 106 with features of other data detected by the medical device 102 (or other instances of the same model as the medical device 102) in other rescue events. For example, the modifier 116 may generate the simulated patient data 114 by combining the patient data 106 with characteristics of other patient data (e.g., detected by another medical device).

In some cases, the simulated patient data 114 is played back to a trainee. For example, the physiological parameter(s) and treatment events indicated by the simulated patient data 114 are displayed to the trainee at a pace that matches the pace of a real-world rescue event. In some cases, the simulated patient data 114 can be played back on the medical device 102 itself. However, running a rescue event simulation on the medical device 102 is problematic in several respects. In various cases, the medical device 102 is a highly specialized, expensive device that is reserved for field use. Accordingly, using the medical device 102 for training purposes may reduce its readiness for sudden rescue events. Moreover, if the medical device 102 is utilized frequently for real-world rescue events, there may be limited opportunities for untrained trainees to engage in training opportunities.

In various implementations of the present disclosure, the simulated patient data 114 is played back on a non-medical device 118, rather than the medical device 102. As used herein, the term “non-medical device” may refer to an electronic device that may a capability of detecting a physiological parameter or of administering a treatment to a subject. The non-medical device 118, for instance, is a general-purpose computing device that lacks connectivity with one or more physiological sensors and/or lacks treatment functionality. In some cases, the non-medical device 118 is a desktop computer, a tablet computer, a mobile phone, or some other type of generic computing device. The non-medical device 118 may include generic user input devices, such as a mouse, trackpad, keyboard, touch sensors, or the like; as well as generic user output devices, such as a display screen, a speaker, or the like.

In particular cases, the non-medical device 118 executes or otherwise embodies a simulated user interface 120. For example, the simulated user interface 120 includes graphics displayed on the display screen of the non-medical device 118. The graphics displayed by the non-medical device 118, for instance, resemble the look and feel of the user interface of the medical device 102. For example, the simulated user interface 120 includes a visual presentation of a box resembling the display of the medical device 102 as well as shapes resembling physical buttons, dials, lights, or other hardware devices integrated with the housing of the medical device 102. In some aspects, a speaker of the non-medical device 118 is configured to output audible alerts, alarms, and other signals that resemble those output by the speaker of the medical device 102. Accordingly, a trainee interacting with the simulated user interface 120 will be prepared for operating the medical device 102.

The non-medical device 118 is configured to present the simulated patient data 114 via the simulated user interface 120. In some cases, the simulated user interface 120 includes one or more waveforms or other indicators of one or more simulated physiological parameters indicated in the simulated patient data 114. In various cases, the simulated user interface 120 is configured to present a simulated recommendation 122 based on the simulated physiological parameter(s). For example, if a simulated ECG in the simulated patient data 114 (which may be derived from the ECG of the patient 104) is indicative of VF, the simulated user interface 120 presents a simulated recommendation 122 to administer an electrotherapy. The simulated recommendation 122, for instance, resembles the look and feel of the treatment recommendation 108.

While playback of the simulated patient data 114 can be informative to the trainee, playback has some limitations. For instance, it may be beneficial for the trainee to practice initiating administration of a treatment. In some cases, it may be beneficial for the trainee to experience and identify artifacted data that could be presented in a real-world rescue event.

In various implementations of the present disclosure, simulated treatments and/or artifacts can be injected into the simulated patient data 114, to enhance the experience of the trainee interacting with the simulated user interface 120. In some cases, the simulated treatments and/or artifacts are based on input signals detected by the non-medical device 118 from the trainee.

In some examples, a simulated treatment selector 124 of the simulated user interface 120 is selected during playback of the simulated patient data 114. In some cases, the simulated treatment selector 124 includes a graphic displayed on the screen of the non-medical device 118 that resembles the treatment selector 110 of the medical device 102. For example, a trainee may review a first segment of physiological parameter data in the simulated patient data 114 that is indicative of a medical condition (e.g., VF). The simulated user interface 120, in various cases, outputs the simulated recommendation 122 indicating that the medical condition can be addressed with a treatment (e.g., defibrillation). In response, the trainee may select the simulated treatment selector 124 (e.g., by pressing a touch sensor on the display of the medical device 118 that overlaps with the graphical representation of the simulated treatment selector 124). In various cases, the non-medical device 118 detects an input signal from the trainee that indicates the selection of a simulated treatment.

The non-medical device 118 outputs a simulated treatment selection 126 to the simulation system 112 based on the detection of the input signal associated with the simulated treatment selector 124. A treatment simulator 128 in the simulation system 112 is configured to alter at least one segment of the simulated patient data 114 based on the simulated treatment selection 126. In some cases, the treatment simulator 128 injects an artifact into the simulated patient data 114 that simulates the administration of the treatment. In various cases, the treatment simulator 128 generates, or alters, a second segment of the simulated patient data 114 based on the simulated treatment. In some examples, the treatment simulator 128 generates a simulated artifact 130 in the physiological parameter data of the simulated patient data 114 that resembles an artifact that would occur in response to administering the treatment to a subject. For instance, the treatment simulator 128 is configured to generate the simulated artifact 130 that resembles a response in the physiological parameter(s) of the patient 104 to administration of an electrical shock. For instance, the second segment of the simulated patient data 114 includes the simulated artifact 130 of the administration of the selected treatment.

In some examples, the treatment simulator 128 further alters the simulated patient data 114 in order to simulate a more long-term response to the administration of the treatment. For example, if the treatment is appropriate for the medical condition indicated by the first segment of the simulated patient data 114, the treatment simulator 128 may generate a subsequent segment of the simulated patient data 114 that simulates resolution of the medical condition. In particular cases, if administration of an electrical shock is selected, the second segment of the simulated patient data 114 after the simulated electrical shock may indicate simulation of resolution of a shockable arrhythmia.

In some cases, the simulated user interface 120 further includes a simulated artifact selector 132. In some cases, the simulated artifact selector 132 does not resemble any element of the medical device 102. In various examples, the trainee may select the simulated artifact selector 132 in order to cause the simulation system 112 to simulate different types of artifact that the trainee may encounter in real-world rescue scenes. Potential sources of artifact include, for instance, malfunctioning sensors (e.g., sensors are broken or incorrectly connected), misapplied sensors (e.g., electrodes applied at an incorrect position), motion (e.g., during patient transport), administration of treatments (e.g., chest compressions or assisted ventilation), or any combination thereof. In various implementations, the trainee selects a particular type of artifact via the simulated artifact selector 132.

In response to detecting an input signal from the trainee via the simulated artifact selector 132 (e.g., in response to detecting a touch from the trainee at a touch sensor that overlaps the graphic of the simulated artifact selector 132), the non-medical device 118 outputs a simulated artifact selection 134 to the simulation system 112. The simulated artifact selection 134, in some cases, includes data indicating a type of artifact that has been selected by the trainee.

The simulation system 112, in various cases, includes an artifact simulator 136 configured to generate an artifact and generate the artifact into the simulated patient data 114. In some cases, the artifact simulator 136 generates the simulated artifact 130. In some cases, the artifact simulator 136 generates the simulated artifact in response to receiving the simulated artifact selection 134. In some cases, the artifact simulator generates the simulated artifact at a random time and automatically injects the simulated artifact into the simulated patient data 114 without notifying the trainee. Accordingly, in some cases, the trainee may experience the simulated artifact without warning, which can enhance the trainee's overall learning experience using the simulated user interface 120. For example, the artifact simulator 136 may generate the simulated artifact 130 to reflect a simulated administration of a treatment (e.g., the simulated artifact 130 is a chest compression artifact or a ventilation artifact), to reflect a malfunctioning sensor (e.g., the simulated artifact 130 indicates that an electrode accessory has been incompletely plugged into a medical device, or a gel layer on an electrode accessory has been damaged, etc.), a misapplied sensor (e.g., the simulated artifact 130 indicates that an ECG electrode has been applied to an incorrect position on the chest of a patient), motion (e.g., the simulated artifact 130 resembles motion artifact that occurs due to transportation of the patient), or any combination thereof. In various cases, the artifact simulator 136 injects the simulated artifact 130 into a third segment of the simulated patient data 114. In some cases, the artifact simulator 136 further generates an alert output on the simulated user interface 120, wherein the alert specifies the type of artifact being depicted by the simulated user interface 120.

In some cases, the simulation system 112 further generates a simulated event record 138 for later review by the trainee or by other individuals. The simulated event record 138, in various cases, indicates the simulated patient data 114, the simulated treatment selection 126, the simulated artifact selection 134, or any combination thereof. In some cases, the simulated event record 138 is output to an external device. In some examples, the simulated event record 138 is stored within the simulation system 112. According to some cases, another individual can playback the entire simulated rescue event on the non-medical device 118, or some other device, using the simulated event record 138.

Various elements depicted within FIG. 1 can be implemented in hardware and/or software. For example, the medical device 102, the simulation system 112, the non-medical device 118, or any combination thereof, can be implemented on one or more computing devices and/or in software executed by one or more computing devices. In particular examples, the simulation system 112 is executed by the medical device 102, by the non-medical device 118, by one or more additional computing devices (e.g., one or more server computers), or any combination thereof.

Various elements depicted within FIG. 1 include data that can be transmitted over one or more communication interfaces. Communication interfaces can be wired interfaces, wireless interfaces, or combinations thereof. In various cases, the patient data 106, the simulated patient data 114, the simulated treatment selection 126, the simulated artifact selection 134, the simulated event record 138, or any combination thereof, includes data transmitted over one or more communication interfaces.

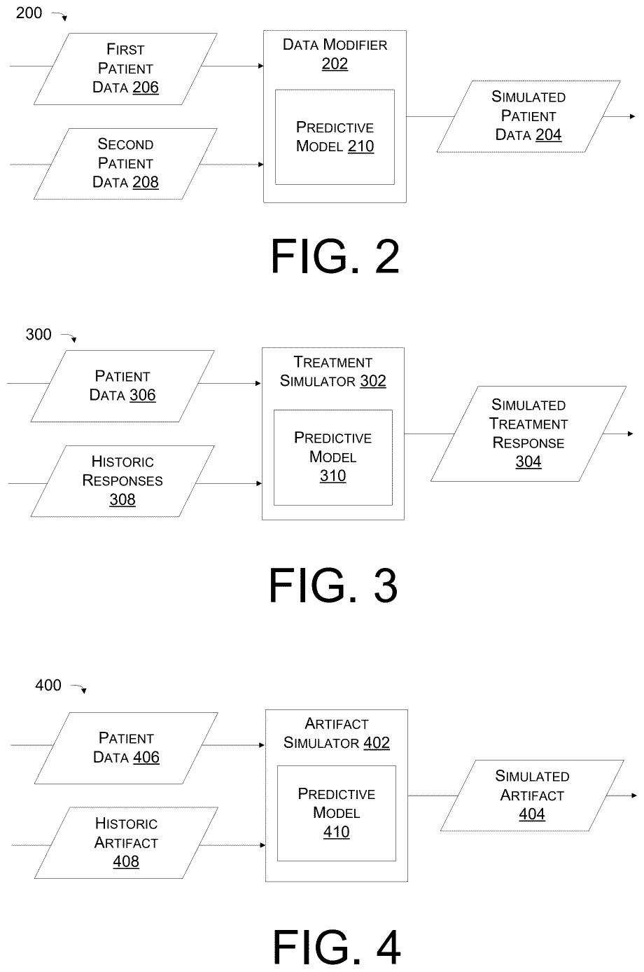

FIG. 2 illustrates example signaling 200 associated with a data modifier 202. In some cases, the data modifier 202 includes the data modifier 116 described above with reference to FIG. 1.

The data modifier 202 is configured to generate simulated patient data 204 for use in medical device simulation. In some examples, the patient data 204 includes data representative of one or more physiological parameters detected from a simulated patient during a simulated rescue event.

In various cases, the data modifier 202 generates the simulated patient data 204 based on data obtained from patients that have undergone real-life rescue events. In various cases, the data modifier 202 generates the simulated patient data 204 based on first patient data 206 and second patient data 208. The first patient data 206, in various implementations, indicates data obtained from a first medical device that treated and/or monitored a first patient during a first rescue event. For instance, the first patient data 206 includes data indicating one or more physiological parameters of the first patient during the first rescue event, one or more parameters of the first medical device (e.g., acceleration, temperature, battery charge level, etc.), one or more treatments administered to the first patient by the first medical device (e.g., an electrotherapy, chest compressions, assisted ventilation, etc.), one or more treatments administered to the first patient by a user of the first medical device during the first rescue event (e.g., administration of a medication, manual chest compressions, etc.), or any combination thereof. The second patient data 208, in various implementations, indicates data obtained from a second medical device that treated and/or monitored a second patient during a second rescue event. For instance, the second patient data 208 includes data indicating one or more physiological parameters of the second patient during the second rescue event, one or more parameters of the second medical device (e.g., acceleration, temperature, battery charge level, etc.), one or more treatments administered to the second patient by the second medical device (e.g., an electrotherapy, chest compressions, assisted ventilation), one or more treatments administered to the second patient by a user of the second medical device during the second rescue event (e.g., administration of a medication, manual chest compressions, etc.), or any combination thereof.

In various cases, the data modifier 202 is configured to identify characteristics of the first patient data 206 and the second patient data 208 that are associated with a common patient condition. For example, the data modifier 202 is configured to identify characteristics of a segment of the first patient data 206 and a segment of the second patient data 208 that correspond to the first patient and the second patient having cardiac arrest, similar cardiac arrhythmias, similar responses to the same treatment (e.g., responses to a medication, responses to administration of an electrotherapy, etc.), similar blood circulation patterns (e.g., spontaneous circulation, lack of spontaneous circulation, etc.), or any combination thereof. In some cases, the data modifier 202 is configured to identify characteristics of the first patient data 206 and the second patient data 208 that are associated with a common device condition. For instance, the data modifier 202 is configured to identify characteristics of a segment of the first patient data 206 and a segment of the second patient data 208 that correspond to the same type of artifact (e.g., treatment artifact, sensor misuse, sensor malfunctions, motion, etc.).

According to various implementations, the data modifier 202 is configured to identify the characteristics using a predictive model 210. In various cases, the predictive model 210 includes one or more machine learning (ML) models. For example, the predictive model 210 includes at least one of an artificial neural network (e.g., a convolutional neural network, a multi-layer perceptron, etc.), a transformer, a nearest neighbor model (e.g., a k-nearest neighbor model), a regression analysis model, a clustering model, a principal components analysis model, a gradient boosting model, a random forest, a support vector machine (SVM), or a probabilistic classifier (e.g., a naïve Bayes classifier). The ML model(s) in the predictive model 210 are defined by various parameters.

The parameters of the ML model(s) are optimized based on the first patient data 206 and the second patient data 208. For instance, the ML model(s) are optimized to detect the characteristics in the first patient data 206 and the second patient data 208 that are indicative of the patient condition(s) and/or device condition(s). In various cases, the ML model(s) are trained using a supervised learning technique. For example, a training data set includes training input data (e.g., at least a portion of the first patient data 206 and/or the second patient data 208) and training output data (e.g., labels indicating the patient condition(s) and/or device condition(s) indicated by the at least portion of the first patient data 206 and/or the second patient data 208). The training input data is input into the predictive model 210. One or more transformations (e.g., computations) are performed on the training input data based on the parameters of the predictive model 210 in order to generate computed output data. The training output data is compared to the computed output data. For instance, a loss is computed between the training output data and the computed output data. In various cases, the parameters of the predictive model 210 are adjusted in order to minimize the loss. Once the loss is sufficiently minimized (e.g., the loss is below a threshold), the predictive model 210 is trained.

When the predictive model 210 is trained, the predictive model 210 is ready to identify the relevant characteristics in segments of the first patient data 206 and the second patient data 208. For example, a segment of the first patient data 206 is input into the predictive model 210. Using the predictive model 210, the segment is classified as corresponding to the patient condition(s) and/or the device condition(s) of interest. When classified, the segment is defined by the data modifier 202 as including a relevant characteristic. In various cases, characteristics are identified in various segments of the first patient data 206 and the second patient data 208.

The data modifier 202, for example, generates the simulated patient data 204 based on the classified segments of the first patient data 206 and the second patient data 208. For example, the data modifier 202 synthesizes the simulated patient data 204 based on the segments of the first patient data 206 and the second patient data 208 that have been classified as corresponding to a predetermined patient condition and/or device condition of interest.

In some implementations, the predictive model 210 includes a generative ML model configured to generate the simulated patient data 204 based on the first patient data 206 and the second patient data 208. Examples of generative ML models include, for instance, variational autoencoders, generative adversarial networks, transformers (e.g., generative pre-trained transformers), neural networks, and other deep learning models. In various cases, the generative ML model is trained using supervised, semi-supervised, or unsupervised learning techniques.

In some cases, the data modifier 202 additionally smooths transitions between the classified segments, so that the simulated patient data 204 is substantially continuous and resembles real-world patient data. In some cases, the data modifier 202 adds randomness (e.g., white noise) into the simulated patient data 204 to further distinguish the simulated patient data 204 from the first patient data 206 and the second patient data 208. In various cases, the data modifier 202 refrains from adding any patient identifying data from the first patient data 206 or the second patient data 208 into the simulated patient data 204.

Although FIG. 2 has been described with respect to synthesizing the simulated patient data 204 using two instances of patient data (the first patient data 206 and the second patient data 208) implementations are not so limited. In some cases, less than or greater than two instances of patient data can be similarly utilized to synthesize the simulated patient data. In some cases, the instances of patient data can be derived from one or more medical devices, one or more patients, one or more rescue events, or any combination thereof.

FIG. 3 illustrates example signaling 300 associated with a treatment simulator 302. In some cases, the treatment simulator 302 includes the treatment simulator 128 described above with reference to FIG. 1.

The treatment simulator 302 is configured to generate a simulated treatment response 304 by analyzing patient data 306 and historic responses 308. In various implementations, the simulated treatment response 304, when added to the patient data 306, causes the patient data 306 to resemble the physiological response of a real patient that has received a treatment. Different types of treatments can be modeled by the treatment simulator 302, such as electrotherapy treatments (e.g., administration of an electrical shock and/or pacing pulses), chest compressions, and the like.

In various cases, the patient data 306 includes simulated data. For example, the patient data 306 of FIG. 3 may be, or at least include, the simulated patient data 204 described with reference to FIG. 2. In various cases, the patient data 306 includes data reflective of one or more physiological parameters of a simulated patient undergoing a medical emergency. For instance, the simulated patient data 204 may include features associated with cardiac arrest. In various implementations, the patient data 306 is indicative of a condition that can be addressed by the treatment modeled by the treatment simulator 302. In some cases, the patient data 306 indicates a selection, by a user, to administer a treatment in a simulated environment. For example, the patient data 306 may further indicate a simulated treatment selection (e.g., the simulated treatment selection 126).

The historic responses 308, in various implementations, include features of real-world patients who have been administered with the treatment being modeled with the treatment simulator 302. In various cases, the historic responses 308 include de-identified physiological parameter data, treatment parameters, timing of events, and the like. For instance, the historic responses 308 may include ECG leads of a patient with VF who receives an electrical shock. In some cases, the historic responses 308 include instances in which the condition has resolved and/or instances in which the condition has recurred after and/or continued during the treatment. In some examples, the historic responses 308 include segments of physiological parameter data obtained both before and after the treatment is administered. In various cases, the historic responses 308 includes data indicating treatment parameters, such as energy levels, magnitude, depth, frequency, waveform shape (e.g., biphasic and/or monophasic, in the case of electrical shock administration), or any combination thereof. In some examples, the historic responses 308 also indicate times at which the treatment was administered, such as relative to the physiological parameter data indicated in the historic responses 308.

In various implementations, the treatment simulator includes a predictive model 310 configured to identify, in the historic responses 308, features associated with the applied treatments. In various cases, the predictive model 310 includes one or more ML models. For example, the predictive model 310 includes at least one of an artificial neural network (e.g., a convolutional neural network, a multi-layer perceptron, etc.), a transformer, a nearest neighbor model (e.g., a k-nearest neighbor model), a regression analysis model, a clustering model, a principal components analysis model, a gradient boosting model, a random forest, a support vector machine (SVM), or a probabilistic classifier (e.g., a naïve Bayes classifier). The ML model(s) in the predictive model 310 are defined by various parameters.

The parameters of the ML model(s) are optimized based on the historic responses 308. For instance, the ML model(s) are optimized to detect the characteristics in the historic responses 308 that are indicative of the administered treatments and/or their responses. In various cases, the ML model(s) are trained using a supervised learning technique. For example, a training data set includes training input data (e.g., at least a portion of the historic responses 308 indicating pre-treatment physiological parameter data and the parameters of the administered treatment) and training output data (e.g., post-treatment physiological parameter data). The training input data is input into the predictive model 310. One or more transformations (e.g., computations) are performed on the training input data based on the parameters of the predictive model 310 in order to generate computed output data. The training output data is compared to the computed output data. For instance, a loss is computed between the training output data and the computed output data. In various cases, the parameters of the predictive model 310 are adjusted in order to minimize the loss. Once the loss is sufficiently minimized (e.g., the loss is below a threshold), the predictive model 310 is trained.

When the predictive model 310 is trained, the predictive model 310 is ready to generate the simulated treatment response 304. For example, a segment of the patient data 306 prior to the selection of the treatment is input into the predictive model 210. In some cases, the selected treatment parameters are also input into the predictive model 310. In various implementations, the predictive model 310 identifies characteristics of the segments of the patient data 306 that are common to pre-treatment segments of the historic responses 308. In some implementations, the predictive model 310 further identifies characteristics of the segments in the patient data 306 that correspond to the treatment parameter(s) indicated in the patient data 306. The treatment simulator 302 generates the simulated treatment response 304 based on the characteristics identified by the predictive model 310. For instance, the simulated treatment response 304 may include a combination of physiological parameter data in the historic responses 308 that correspond to the same or similar treatments to the selected treatment.

In some implementations, the predictive model 310 includes a generative ML model configured to generate the simulated treatment response 304 based on the historic responses 308. Examples of generative ML models include, for instance, variational autoencoders, generative adversarial networks, transformers (e.g., generative pre-trained transformers), neural networks, and other deep learning models. In various cases, the generative ML model is trained using supervised, semi-supervised, or unsupervised learning techniques.

In various cases, the treatment simulator 302 synthesizes the simulated treatment response 304 based on the characteristics of the patient data 306 that are predictive of a patient response to the selected treatment. In some cases, the treatment simulator 302 injects the simulated treatment response 304 into a datastream including the patient data 306, which can be output to the user.

FIG. 4 illustrates example signaling 400 associated with an artifact simulator 402. In some cases, the artifact simulator 402 includes the artifact simulator 136 described above with reference to FIG. 1.

The artifact simulator 402 is configured to generate a simulated artifact artifact 404 by analyzing patient data 406 and historic artifact 408. In various implementations, the simulated artifact 404, when added to the patient data 406, causes the patient data 406 to resemble the presence of artifact. Different types of artifacts can be modeled by the artifact simulator 402, such as chest compression artifact, ventilation artifact, artifact associated with misapplied sensors, or the like.

In various cases, the patient data 406 includes simulated data. For example, the patient data 406 of FIG. 4 may be, or at least include, the simulated patient data 204 described with reference to FIG. 2. In various cases, the patient data 406 includes data reflective of one or more physiological parameters of a simulated patient undergoing a medical emergency. For instance, the simulated patient data 204 may include features associated with cardiac arrest. In some cases, the patient data 406 indicates a selection, by a user, to add a type of artifact into the patent data 406. For example, the patient data 406 may further indicate a simulated artifact selection (e.g., the simulated artifact selection 134).

The historic artifact 408, in various implementations, include physiological parameter data of real-world patients, wherein the physiological parameter data includes at least one source of artifact. In various cases, the historic artifact 408 include de-identified physiological parameter data, types of artifact, timing of events, and the like. For instance, the historic artifact 408 may include data indicating an ECG of a patient receiving chest compressions, such that the data includes a chest compression artifact. In various cases, the historic artifact 408 includes labels indicating the type of artifact present in the corresponding segments of the physiological parameter data. In some examples, the historic artifact 408 also indicate times at which the artifact is present, such as relative to the physiological parameter data indicated in the historic artifact 408.

In various implementations, the artifact simulator includes a predictive model 310 configured to identify, in the historic artifact 408, features associated with the artifacts present in the physiological parameter data. In various cases, the predictive model 310 includes one or more ML models. For example, the predictive model 310 includes at least one of an artificial neural network (e.g., a convolutional neural network, a multi-layer perceptron, etc.), a transformer, a nearest neighbor model (e.g., a k-nearest neighbor model), a regression analysis model, a clustering model, a principal components analysis model, a gradient boosting model, a random forest, a support vector machine (SVM), or a probabilistic classifier (e.g., a naïve Bayes classifier). The ML model(s) in the predictive model 310 are defined by various parameters.

The parameters of the ML model(s) are optimized based on the historic artifact 408. For instance, the ML model(s) are optimized to detect the characteristics in the historic artifact 408 that are indicative of the selected artifact. In various cases, the ML model(s) are trained using a supervised learning technique. For example, a training data set includes training input data (e.g., at least a portion of the historic artifact 408 indicating physiological parameter data with the artifact present) and training output data (e.g., labels indicating the type of artifact present). The training input data is input into the predictive model 410. One or more transformations (e.g., computations) are performed on the training input data based on the parameters of the predictive model 410 in order to generate computed output data. The training output data is compared to the computed output data. For instance, a loss is computed between the training output data and the computed output data. In various cases, the parameters of the predictive model 410 are adjusted in order to minimize the loss. Once the loss is sufficiently minimized (e.g., the loss is below a threshold), the predictive model 410 is trained.

When the predictive model 410 is trained, the predictive model 410 is ready to generate the simulated artifact 404. For example, a segment of the patient data 406 prior to the selection of the artifact is input into the predictive model 410. In some cases, an indication of the selected artifact is also input into the predictive model 410. In various implementations, the predictive model 310 identifies characteristics of the selected artifact that are present in the historic artifact 408. The artifact simulator 402 generates the simulated artifact 404 based on the characteristics identified by the predictive model 410. For instance, the simulated artifact 404 may include a combination of physiological parameter data in the historic artifact 408 that correspond to the same or similar instances of the selected type of artifact.

In some implementations, the predictive model 410 includes a generative ML model configured to generate the simulated artifact 404 based on the historic artifact 408. Examples of generative ML models include, for instance, variational autoencoders, generative adversarial networks, transformers (e.g., generative pre-trained transformers), neural networks, and other deep learning models. In various cases, the generative ML model is trained using supervised, semi-supervised, or unsupervised learning techniques.

For example, the artifact simulator 402 synthesizes the simulated artifact 404 based on the characteristics of the historic artifact 408 that correspond to the selected artifact. In some cases, the artifact simulator 402 injects the simulated artifact 404 into a datastream including the patient data 406, which can be output to the user.

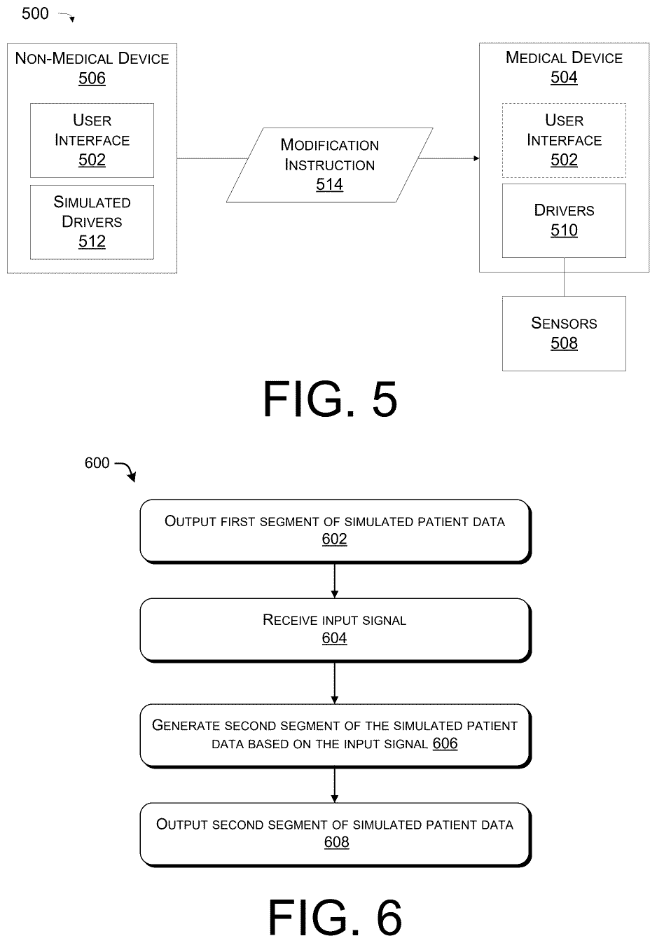

FIG. 5 illustrates example signaling 500 for updating the user interface 502 of a medical device 504 based on a simulation of the user interface 502 on a non-medical device 506. In various implementations, the medical device 504 is the medical device 102, and the non-medical device 504 is the non-medical device 118, which were described with reference to FIG. 1.

In various implementations, the user interface 502 is implemented by a non-medical device 506. The user interface 502 includes software that can also be executed by a medical device 504, and which enables the medical device 504 to receive input signals from a user, and to output signals to the user. In some implementations, the user interface 502 includes a graphical user interface.

When implemented by the medical device 504, the user interface 502 is configured to output data indicative of one or more physiological parameters detected from a patient. In some examples, the medical device 504 communicates with sensors 508 configured to detect the physiological parameter(s) from the patient. For example, the medical device 504 is configured to communicatively couple with the sensors 508 via one or more wireless interface and/or one or more wired interfaces. Although FIG. 5 illustrates that the sensors 508 are outside of the medical device 504, in some cases, the sensors 508 may be a part of the medical device 504 itself.

The sensors 508 generate data indicative of the detected physiological parameter(s). The medical device 504 further includes various drivers 510 configured to convert the data into a form that is usable by the user interface 502. In various implementations, the drivers 510 include software configured to enable communication between the sensors 508 and an operating system (not illustrated) of the medical device 504. The operating system, for instance, executes the user interface 502.

In various implementations, the user interface 502 can be additionally executed on a non-medical device 506. For example, the non-medical device 506 may act as a medical deice simulator by executing the user interface 502. Accordingly, a user can learn to operate the medical device 504 using the user interface 502 executed by the non-medical device 506. In various implementations, the user interface 502 executed by the non-medical device 506 is identical to the user interface 502 executed on the medical device 504. However, the non-medical device 506 may refrain from communicating with any external sensors (e.g., the sensors 508) during a simulation.

Accordingly, the non-medical device 506 executes simulated drivers 512 that substitute for the sensors 508 and drivers 510 of the medical device 504. In some examples, the simulated drivers 512 store and/or generate data that can be usable by the user interface 502. This data, for instance, includes simulated physiological parameter data. In some cases, the data additionally includes simulated treatment responses and/or simulated artifact. In some cases, the simulated drivers 512 include one or more software drivers configured to communicate with a software component and/or memory device configured to generate and/or store the data. Due to the presence of the simulated drivers 512, the same user interface 502 can be executed by the medical device 504 and the non-medical device 506.

During a simulation, or in response to a simulation, a user may desire to modify the user interface 502. In various cases, the user desires to change a visual characteristic of the user interface 502, such as a color, a text size, an icon size, or an icon orientation. The user, for instance, inputs a signal into the non-medical device 506 that specifies the desired modification. The non-medical device 506, in various implementations, generates and transmits a modification instruction 514 based on the signal from the user. The modification instruction 514, for instance, indicates the change to the visual characteristic.

In various examples, the medical device 504 modifies its instance of the user interface 502 based on the modification instruction 514. Accordingly, the simulation of the user interface 502 on the non-medical device 506 can be used to update the instance of the user interface 502 executed on the medical device 504.

FIG. 6 illustrates an example process 600 for simulating a user interface on a non-medical device. The process 600, in various implementations, is executed by an entity including a simulation system (e.g., the simulation system 112), a non-medical device (e.g., the non-medical device 118), a computing device, at least one processor, or any combination thereof.

At 602, the entity outputs a first segment of simulated patient data. In various cases, the patient data indicates one or more physiological parameters of a simulated subject during a simulated rescue event. For instance, the simulated patient data is generated based on altering patient data of at least one real-world subject during at least one real-world rescue event. In some cases, characteristics of multiple instances of patient data are combined in order to generate the simulated patient data. In some cases, an ML model is configured to identify the characteristics and/or to generate the simulated patient data, based on the real-world patient data. In various cases, the characteristics are associated with the medical condition (e.g., VF, VT, AF, bradycardia, lack of spontaneous circulation, lack of spontaneous breathing, etc.) being simulated.

In various cases, the entity generates, or otherwise outputs, a simulated medical device UI indicating the simulated patient data. For example, the simulated medical device is displayed by the entity. In various cases, the simulated medical device UI displays a first segment of the simulated patient data indicating a medical condition that is responsive to a treatment. The simulated medical device UI further, in some cases, displays a recommendation to administer the treatment. The treatment, for instance, is a type of electrotherapy.

At 604, the entity receives an input signal. In some examples, the input signal is an instruction to administer a simulation of the treatment. In some cases, the input signal is an instruction to inject at least one type of artifact (e.g., a chest compression artifact, a ventilation artifact, an artifact indicative of an error in operation of the medical device, an artifact associated with a disconnected sensor, a motion artifact, or an artifact associated with a misused sensor) into the simulated patient data.

At 605, the entity generates a second segment of the simulated patient data based on the input signal 606. For example, the second segment indicates a simulated response to the treatment. In some cases, the segment includes the artifact(s) selected by the input signal. The simulated treatment response and/or the simulated artifact are injected into the simulated patient data, such that the second segment reflects the simulated treatment response and/or the simulated artifact.

At 606, the entity outputs the second segment of the simulated patient data. Accordingly, in various cases, the simulated user interface reflects the simulated treatment and/or artifact. In some cases, the simulated patient data is stored in the form of a simulated event record. For example, the simulated patient data is stored in memory of the entity or exported for storage by another entity.

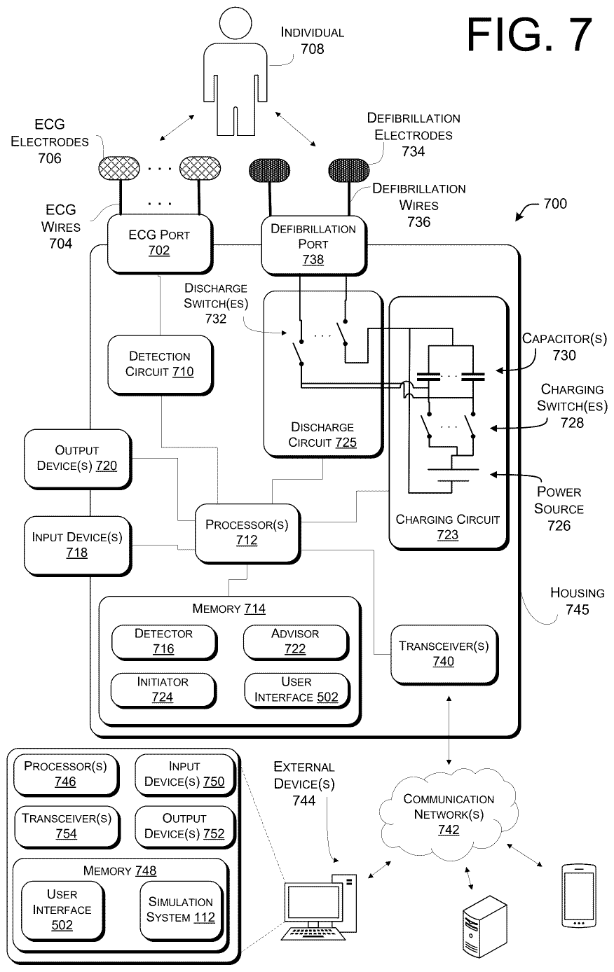

FIG. 7 illustrates an example of an external defibrillator 700 associated with various functions described herein. For example, the external defibrillator 700 is the medical device 102 described above with reference to FIG. 1.

The external defibrillator 700 includes an electrocardiogram (ECG) port 702 connected to multiple ECG wires 704. In some cases, the ECG wires 704 are removeable from the ECG port 702. For instance, the ECG wires 704 are plugged into the ECG port 702 via connectors. The ECG wires 704 are connected to ECG electrodes 706, respectively. In various implementations, the ECG electrodes 706 are disposed on different locations on an individual 708. A detection circuit 710 is configured to detect relative voltages between the ECG electrodes 706. These voltages are indicative of the electrical activity of the heart of the individual 708.

In various implementations, the ECG electrodes 706 are in contact with the different locations on the skin of the individual 708. In some examples, a first one of the ECG electrodes 706 is placed on the skin between the heart and right arm of the individual 708, a second one of the ECG electrodes 706 is placed on the skin between the heart and left arm of the individual 708, and a third one of the ECG electrodes 706 is placed on the skin between the heart and a leg (either the left leg or the right leg) of the individual 708. In these examples, the detection circuit 710 is configured to measure the relative voltages between the first, second, and third ECG electrodes 706. Respective pairings of the ECG electrodes 706 are referred to as “leads,” and the voltages between the pairs of ECG electrodes 706 are known as “lead voltages.” In some examples, more than three ECG electrodes 706 are included, such that 5-lead or 12-lead ECG signals are detected by the detection circuit 710.

The detection circuit 710 includes at least one analog circuit, at least one digital circuit, or a combination thereof. The detection circuit 710 receives the analog electrical signals from the ECG electrodes 706, via the ECG port 702 and the ECG wires 704. In some cases, the detection circuit 710 includes one or more analog filters configured to filter noise and/or artifact from the electrical signals. The detection circuit 710 includes an analog-to-digital (ADC) in various examples. The detection circuit 710 generates a digital signal indicative of the analog electrical signals from the ECG electrodes 706. This digital signal can be referred to as an “ECG signal” or an “ECG.”

In some cases, the detection circuit 710 further detects an electrical impedance between at least one pair of the ECG electrodes 706. For example, the detection circuit 710 includes, or otherwise controls, a power source that applies a known voltage (or current) across a pair of the ECG electrodes 706 and detects a resultant current (or voltage) between the pair of the ECG electrodes 706. The impedance is generated based on the applied signal (voltage or current) and the resultant signal (current or voltage). In various cases, the impedance corresponds to respiration of the individual 708, chest compressions performed on the individual 708, and other physiological states of the individual 708. In various examples, the detection circuit 710 includes one or more analog filters configured to filter noise and/or artifact from the resultant signal. The detection circuit 710 generates a digital signal indicative of the impedance using an ADC. This digital signal can be referred to as an “impedance signal” or an “impedance.”

The detection circuit 710 provides the ECG signal and/or the impedance signal one or more processors 712 in the external defibrillator 700. In some implementations, the processor(s) 712 includes a central processing unit (CPU), a graphics processing unit (GPU), both CPU and GPU, or other processing unit or component known in the art.

The processor(s) 712 is operably connected to memory 714. In various implementations, the memory 714 is volatile (such as random access memory (RAM)), non-volatile (such as read only memory (ROM), flash memory, etc.) or some combination of the two. The memory 714 stores instructions that, when executed by the processor(s) 712, causes the processor(s) 712 to perform various operations. In various examples, the memory 714 stores methods, threads, processes, applications, objects, modules, any other sort of executable instruction, or a combination thereof. In some cases, the memory 714 stores files, databases, or a combination thereof. In some examples, the memory 714 includes, but is not limited to, RAM, ROM, electrically erasable programmable read-only memory (EEPROM), flash memory, or any other memory technology. In some examples, the memory 714 includes one or more of CD-ROMs, digital versatile discs (DVDs), content-addressable memory (CAM), or other optical storage, magnetic cassettes, magnetic tape, magnetic disk storage or other magnetic storage devices, or any other medium which can be used to store the desired information and which can be accessed by the processor(s) 712 and/or the external defibrillator 700. In some cases, the memory 714 at least temporarily stores the ECG signal and/or the impedance signal.

In various examples, the memory 714 includes a detector 716, which causes the processor(s) 712 to determine, based on the ECG signal and/or the impedance signal, whether the individual 708 is exhibiting a particular heart rhythm. For instance, the processor(s) 712 determines whether the individual 708 is experiencing a shockable rhythm that is treatable by defibrillation. Examples of shockable rhythms include ventricular fibrillation (VF) and ventricular tachycardia (V-Tach). In some examples, the processor(s) 712 determines whether any of a variety of different rhythms (e.g., asystole, sinus rhythm, atrial fibrillation (AF), etc.) are present in the ECG signal.

The processor(s) 712 is operably connected to one or more input devices 718 and one or more output devices 720. Collectively, the input device(s) 718 and the output device(s) 720 function as an interface between a user and the defibrillator 700. The input device(s) 718 is configured to receive an input from a user and includes at least one of a keypad, a cursor control, a touch-sensitive display, a voice input device (e.g., a microphone), a haptic feedback device (e.g., a gyroscope), or any combination thereof. The output device(s) 720 includes at least one of a display, a speaker, a haptic output device, a printer, or any combination thereof. In various examples, the processor(s) 712 causes a display among the input device(s) 718 to visually output a waveform of the ECG signal and/or the impedance signal. In some implementations, the input device(s) 718 includes one or more touch sensors, the output device(s) 720 includes a display screen, and the touch sensor(s) are integrated with the display screen. Thus, in some cases, the external defibrillator 700 includes a touchscreen configured to receive user input signal(s) and visually output physiological parameters, such as the ECG signal and/or the impedance signal.

In various implementations, the input device(s) 718 further include, or are otherwise connected to, one or more physiological sensors. The physiological sensor(s), for instance, are configured to detect one or more physiological parameters of the individual 708. Examples of the physiological sensor(s) include a blood pressure sensor (e.g., a blood pressure cuff, invasive blood pressure sensor, or the like), an airway sensor (e.g., a sensor configured to detect a partial pressure of CO₂ and/or O₂ in an airway of the individual 708), a blood oxygenation sensor (e.g., a pulse oximeter, regional oxygenation sensor, or the like), a thermometer, a pulse sensor, a blood flow sensor (e.g., an ultrasound transducer configured to detect blood flow using Doppler-based techniques), an airway pressure sensor, or any combination thereof. The input device(s) 718, in some cases, includes one or more sensors configured to detect other characteristics of the individual 708. For example, the input device(s) 718 includes an accelerometer, gyroscope, microphone, or any combination thereof. In various implementations, the processor(s) 712 is configured to assess a condition of the individual 708 by analyzing data derived from signals detected by the input device(s) 718.

In some examples, the memory 714 includes an advisor 722, which, when executed by the processor(s) 712, causes the processor(s) 712 to generate advice and/or control the output device(s) 720 to output the advice to a user (e.g., a rescuer). In some examples, the processor(s) 712 provides, or causes the output device(s) 720 to provide, an instruction to perform CPR on the individual 708. In some cases, the processor(s) 712 evaluates, based on the ECG signal, the impedance signal, or other physiological parameters, CPR being performed on the individual 708 and causes the output device(s) 720 to provide feedback about the CPR in the instruction. According to some examples, the processor(s) 712, upon identifying that a shockable rhythm is present in the ECG signal, causes the output device(s) 720 to output an instruction and/or recommendation to administer a defibrillation shock to the individual 708.

The memory 714 also includes an initiator 724 which, when executed by the processor(s) 712, causes the processor(s) 712 to control other elements of the external defibrillator 700 in order to administer a defibrillation shock to the individual 708. In some examples, the processor(s) 712 executing the initiator 724 selectively causes the administration of the defibrillation shock based on determining that the individual 708 is exhibiting the shockable rhythm and/or based on an input from a user (received, e.g., by the input device(s) 718. In some cases, the processor(s) 712 causes the defibrillation shock to be output at a particular time, which is determined by the processor(s) 712 based on the ECG signal and/or the impedance signal.

The processor(s) 712 is operably connected to a charging circuit 723 and a discharge circuit 725. In various implementations, the charging circuit 723 includes a power source 726, one or more charging switches 728, and one or more capacitors 730. The power source 726 includes, for instance, a battery. The processor(s) 712 initiates a defibrillation shock by causing the power source 726 to charge at least one capacitor among the capacitor(s) 730. For example, the processor(s) 712 activates at least one of the charging switch(es) 728 in the charging circuit 723 to complete a first circuit connecting the power source 726 and the capacitor to be charged. Then, the processor(s) 712 causes the discharge circuit 725 to discharge energy stored in the charged capacitor across a pair of defibrillation electrodes 734, which are in contact with the individual 708. For example, the processor(s) 712 deactivates the charging switch(es) 728 completing the first circuit between the capacitor(s) 730 and the power source 726, and activates one or more discharge switches 732 completing a second circuit connecting the charged capacitor 730 and at least a portion of the individual 708 disposed between defibrillation electrodes 734.

The energy is discharged from the defibrillation electrodes 734 in the form of a defibrillation shock. For example, the defibrillation electrodes 734 are connected to the skin of the individual 708 and located at positions on different sides of the heart of the individual 708, such that the defibrillation shock is applied across the heart of the individual 708. The defibrillation shock, in various examples, depolarizes a significant number of heart cells in a short amount of time. The defibrillation shock, for example, interrupts the propagation of the shockable rhythm (e.g., VF or V-Tach) through the heart. In some examples, the defibrillation shock is 200 J or greater with a duration of about 0.015 seconds. In some cases, the defibrillation shock has a multiphasic (e.g., biphasic) waveform. The discharge switch(es) 732 are controlled by the processor(s) 712, for example. In various implementations, the defibrillation electrodes 734 are connected to defibrillation leads 736. The defibrillation wires 736 are connected to a defibrillation port 738, in implementations. According to various examples, the defibrillation wires 736 are removable from the defibrillation port 738. For example, the defibrillation wires 736 are plugged into the defibrillation port 738.

In various implementations, the processor(s) 712 is operably connected to one or more transceivers 740 that transmit and/or receive data over one or more communication networks 742. For example, the transceiver(s) 740 includes a network interface card (NIC), a network adapter, a local area network (LAN) adapter, or a physical, virtual, or logical address to connect to the various external devices and/or systems. In various examples, the transceiver(s) 740 includes any sort of wireless transceivers capable of engaging in wireless communication (e.g., radio frequency (RF) communication). For example, the communication network(s) 742 includes one or more wireless networks that include a 3^{rd} Generation Partnership Project (3GPP) network, such as a Long Term Evolution (LTE) radio access network (RAN) (e.g., over one or more LTE bands), a New Radio (NR) RAN (e.g., over one or more NR bands), or a combination thereof. In some cases, the transceiver(s) 740 includes other wireless modems, such as a modem for engaging in WI-FI®, WIGIG®, WIMAX®, BLUETOOTH®, or infrared communication over the communication network(s) 742.

The defibrillator 700 is configured to transmit and/or receive data (e.g., ECG data, impedance data, data indicative of one or more detected heart rhythms of the individual 708, data indicative of one or more defibrillation shocks administered to the individual 708, etc.) with one or more external devices 744 via the communication network(s) 742. The external devices 744 include, for instance, mobile devices (e.g., mobile phones, smart watches, etc.), Internet of Things (IoT) devices, medical devices, computers (e.g., laptop devices, servers, etc.), or any other type of computing device configured to communicate over the communication network(s) 742. In some examples, the external device(s) 744 is located remotely from the defibrillator 700, such as at a remote clinical environment (e.g., a hospital). According to various implementations, the processor(s) 712 causes the transceiver(s) 740 to transmit data to the external device(s) 744. In some cases, the transceiver(s) 740 receives data from the external device(s) 744 and the transceiver(s) 740 provide the received data to the processor(s) 712 for further analysis.

In various implementations, the external device(s) 744 includes a non-medical device (e.g., the non-medical device 118) including one or more processors 746, memory 748, one or more input devices 750, one or more output devices 752, and one or more transceivers 754. Any type of processor, memory, input device, output device, or transceiver described elsewhere herein can be utilized in the non-medical device. Further, the memory 748 stores an instance of the user interface 502 that, when executed by the processor(s) 746, cause the non-medical device to output a simulation of a rescue event using the user interface 502. Although not specifically illustrated in FIG. 7, the memory 748 may further include instructions for executing the simulation system 112 described above with reference to FIG. 1.

In various implementations, the external defibrillator 700 also includes a housing 745 that at least partially encloses other elements of the external defibrillator 700. For example, the housing 745 encloses the detection circuit 710, the processor(s) 712, the memory 714, the charging circuit 723, the transceiver(s) 740, or any combination thereof. In some cases, the input device(s) 718 and output device(s) 720 extend from an interior space at least partially surrounded by the housing 745 through a wall of the housing 745. In various examples, the housing 745 acts as a barrier to moisture, electrical interference, and/or dust, thereby protecting various components in the external defibrillator 700 from damage.

In some implementations, the external defibrillator 700 is an automated external defibrillator (AED) operated by an untrained user (e.g., a bystander, layperson, etc.) and can be operated in an automatic mode. In automatic mode, the processor(s) 712 automatically identifies a rhythm in the ECG signal, makes a decision whether to administer a defibrillation shock, charges the capacitor(s) 730, discharges the capacitor(s) 730, or any combination thereof. In some cases, the processor(s) 712 controls the output device(s) 720 to output (e.g., display) a simplified user interface to the untrained user. For example, the processor(s) 712 refrains from causing the output device(s) 720 to display a waveform of the ECG signal and/or the impedance signal to the untrained user, in order to simplify operation of the external defibrillator 700.

In some examples, the external defibrillator 700 is a monitor-defibrillator utilized by a trained user (e.g., a clinician, an emergency responder, etc.) and can be operated in a manual mode or the automatic mode. When the external defibrillator 700 operates in manual mode, the processor(s) 712 cause the output device(s) 720 to display a variety of information that may be relevant to the trained user, such as waveforms indicating the ECG data and/or impedance data, notifications about detected heart rhythms, and the like.

### EXAMPLE CLAUSES

The following clauses provide various examples of implementations of the present disclosure:
1. A non-medical device, including: a display; an input device configured to receive an input signal from a user; and a processor configured to: receive patient data indicating an electrocardiogram (ECG), an end-tidal carbon dioxide (CO₂) (EtCO₂), and a pulse oxygenation (SpO₂) detected from a subject by a monitor-defibrillator during a rescue event; generate simulated patient data by injecting, into the patient data, a simulated chest compression artifact; generate a simulated defibrillator user interface (UI) indicating the simulated patient data; cause the display to visually present the simulated defibrillator UI by: causing the display to visually present a first segment of the simulated patient data indicating ventricular fibrillation (VF); causing the display to visually present a recommendation to administer an electrical shock; and in response to the display visually presenting the recommendation to administer the electrical shock and in response to the input device receiving the input signal, causing the display to visually present a second segment of the simulated patient data indicating a simulated response to the electrical shock.
2. The non-medical device of clause 1, the patient data being first patient data, the subject being a first subject, the monitor-defibrillator being a first monitor-defibrillator, the rescue event being a first rescue event, wherein the processor is configured to generate the simulated patient data further by combining the first patient data with second patient data indicating an ECG, an EtCO₂, and an SpO₂ detected from a second subject by a second monitor-defibrillator during second rescue event.
3. The non-medical device of clause 1 or 2, wherein the processor is configured to generate the simulated patient data includes injecting, into the patient data, a simulated malfunction artifact indicating that a sensor has been disconnected from the monitor-defibrillator during the rescue event, the sensor being configured to detect the EtCO₂ or the SpO₂, and wherein the simulated defibrillator UI further includes an error notification indicating the sensor that has been disconnected from the monitor-defibrillator.
4. A computing device, including: a display; an input device configured to receive an input signal from a user; and a processor configured to: receive patient data indicating physiological parameters of a subject during a rescue event; generate simulated patient data by altering the patient data, the simulated patient data indicating physiological parameters of a simulated subject during a simulated rescue event; generate a simulated medical device user interface (UI) indicating the simulated patient data; cause the display to visually present the simulated medical device UI by: causing the display to visually present a first segment of the simulated patient data indicating a medical condition that is responsive to a treatment; causing the display to visually present a recommendation to administer the treatment; and in response to the display visually presenting the recommendation to administer the treatment and in response to the input device receiving the input signal, causing the display to visually present a second segment of the simulated patient data indicating a simulated response to the treatment.
5. The computing device of clause 4, wherein the processor is configured to generate the simulated patient data by altering the first patient data by: injecting, into the patient data, a simulated artifact.
6. The computing device of clause 5, wherein the simulated artifact includes a chest compression artifact or a ventilation artifact.
7. The computing device of clause 5 or 6, wherein the simulated artifact is indicative of an error in operation of a medical device, and wherein the simulated medical device UI further indicates the error.
8. The computing device of clause 7, wherein the error is indicates a disconnected sensor, a motion artifact, or a misused sensor.
9. The computing device of any of clauses 5 to 8, wherein the processor is further configured to: generate the simulated artifact by analyzing the simulated patient data.
10.The computing device of any of clauses 4 to 9, the patient data being first patient data, the subject being a first subject, the rescue event being a first rescue event, wherein the processor is configured to generate the simulated patient data by altering the first patient data by: combining characteristics of the first patient data with characteristics of second patient data indicating physiological parameters of a second subject during a second rescue event.
11.The computing device of clause 10, wherein the processor is configured to generate the characteristics of the first patient data with characteristics of the second patient data by: inputting, into a machine learning model configured to identify the characteristics of the first patient data and the characteristics of the second patient data, the first patient data and the second patient data; and receiving, from the machine learning model, the simulated patient data.
12.The computing device of clause 10 or 11, wherein the characteristics of the first patient data and the characteristics of the second patient data are associated with the medical condition.
13.The computing device of any of clauses 4 to 12, wherein the physiological parameters include ECG, and Wherein the medical condition includes ventricular fibrillation (VF), ventricular tachycardia (VT), atrial fibrillation (AF), or bradycardia.
14.The computing device of any of clauses 4 to 13, wherein the treatment includes an electrotherapy.
15.The computing device of any of clauses 4 to 14, the input signal being a first input signal, wherein the input device is further configured to detect a second input signal from the user, wherein the processor is further configured to modify a visual characteristic of the simulated medical device UI in response to the second input signal, and wherein the computing device is further configured to output, to a medical device, an instruction to modify the visual characteristic of a medical device UI output by the medical device.
16.The computing device of clause 15, wherein the visual characteristic includes a color, a text size, an icon size, or an icon orientation.
17.The computing device of any of clauses 4 to 16, wherein the processor is further configured to: generate a simulated event record including the simulated patient data and an indication of the input signal; and cause the display to visually present the simulated event record.
18.The computing device of clause 17, further including: memory configured to store the simulated event record.
19.The computing device of any of clauses 4 to 18, wherein the computing device is a non-medical device.
20. A method performed by a computing device, the method including: receiving patient data indicating physiological parameters of a subject during a rescue event; generating simulated patient data by altering the patient data, the simulated patient data indicating physiological parameters of a simulated subject during a simulated rescue event; generating a simulated medical device user interface (UI) indicating the simulated patient data; receiving an input signal from a user; displaying the simulated medical device UI by: displaying a first segment of the simulated patient data indicating a medical condition that is responsive to a treatment; displaying a recommendation to administer the treatment; and in response to displaying the recommendation to administer the treatment and in response receiving the input signal, displaying a second segment of the simulated patient data indicating a simulated response to the treatment.
21.The method of clause 20, wherein generating the simulated patient data by altering the first patient data includes: injecting, into the patient data, a simulated artifact.
22.The method of clause 21, wherein the simulated artifact includes a chest compression artifact or a ventilation artifact.
23.The method of clause 21 or 22, wherein the simulated artifact is indicative of an error in operation of a medical device, and wherein the simulated medical device UI further indicates the error.
24.The method of clause 23, wherein the error is indicates a disconnected sensor, a motion artifact, or a misused sensor.
25.The method of any of clauses 21 to 24, further including: generating the simulated artifact by analyzing the simulated patient data.
26.The method of any of clauses 20 to 25, the patient data being first patient data, the subject being a first subject, the rescue event being a first rescue event, wherein generating the simulated patient data by altering the first patient data includes: combining characteristics of the first patient data with characteristics of second patient data indicating physiological parameters of a second subject during a second rescue event.
27.The method of clause 26, wherein combining characteristics of the first patient data with characteristics of the second patient data includes: inputting, into a machine learning model configured to identify the characteristics of the first patient data and the characteristics of the second patient data, the first patient data and the second patient data; and receiving, from the machine learning model, the simulated patient data.
28.The method of clause 26 or 27, wherein the characteristics of the first patient data and the characteristics of the second patient data are associated with the medical condition.
29.The method of any of clauses 20 to 28, wherein the physiological parameters include ECG, and wherein the medical condition includes ventricular fibrillation (VF), ventricular tachycardia (VT), atrial fibrillation (AF), or bradycardia.
30.The method of any of clauses 20 to 29, wherein the treatment includes an electrotherapy.
31.The method of any of clauses 20 to 30, the input signal being a first input signal, wherein the input device is further configured to detect a second input signal from the user, the method further including: modifying a visual characteristic of the simulated medical device UI in response to the second input signal, and outputting, to a medical device, an instruction to modify the visual characteristic of a medical device UI output by the medical device.
32.The method of clause 31, wherein the visual characteristic includes a color, a text size, an icon size, or an icon orientation.
33.The method of any of clauses 20 to 32, further including: generate a simulated event record including the simulated patient data and an indication of the input signal; and cause the display to visually present the simulated event record.
34.The method of clause 33, further including: storing, in memory, the simulated event record.
35.The method of any of clauses 20 to 34, wherein the computing device is a non-medical device.

### CONCLUSION

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A non-medical device, comprising:
a display;
an input device configured to receive an input signal from a user; and
a processor configured to:
receive patient data indicating an electrocardiogram (ECG), an end-tidal carbon dioxide (CO₂) (EtCO₂), and a pulse oxygenation (SpO₂) detected from a subject by a monitor-defibrillator during a rescue event;
generate simulated patient data by injecting, into the patient data, a simulated chest compression artifact;
generate a simulated defibrillator user interface (UI) indicating the simulated patient data;
cause the display to visually present the simulated defibrillator UI by:
causing the display to visually present a first segment of the simulated patient data indicating ventricular fibrillation (VF);
causing the display to visually present a recommendation to administer an electrical shock; and
in response to the display visually presenting the recommendation to administer the electrical shock and in response to the input device receiving the input signal, causing the display to visually present a second segment of the simulated patient data indicating a simulated response to the electrical shock.

2. The non-medical device of claim 1, the patient data being first patient data, the subject being a first subject, the monitor-defibrillator being a first monitor-defibrillator, the rescue event being a first rescue event, wherein the processor is configured to generate the simulated patient data further by combining the first patient data with second patient data indicating an ECG, an EtCO₂, and an SpO₂ detected from a second subject by a second monitor-defibrillator during second rescue event.

3. The non-medical device of claim 1, wherein the processor is configured to generate the simulated patient data comprises injecting, into the patient data, a simulated malfunction artifact indicating that a sensor has been disconnected from the monitor-defibrillator during the rescue event, the sensor being configured to detect the EtCO₂ or the SpO₂, and wherein the simulated defibrillator UI further comprises an error notification indicating the sensor that has been disconnected from the monitor-defibrillator.

4. A computing device, comprising:
a display;
an input device configured to receive an input signal from a user; and
a processor configured to:
receive patient data indicating physiological parameters of a subject during a rescue event;
generate simulated patient data by altering the patient data, the simulated patient data indicating physiological parameters of a simulated subject during a simulated rescue event;
generate a simulated medical device user interface (UI) indicating the simulated patient data;
cause the display to visually present the simulated medical device UI by:
causing the display to visually present a first segment of the simulated patient data indicating a medical condition that is responsive to a treatment;
causing the display to visually present a recommendation to administer the treatment; and
in response to the display visually presenting the recommendation to administer the treatment and in response to the input device receiving the input signal, causing the display to visually present a second segment of the simulated patient data indicating a simulated response to the treatment.

5. The computing device of claim 4, wherein the processor is configured to generate the simulated patient data by altering the first patient data by:
injecting, into the patient data, a simulated artifact.

6. The computing device of claim 5, wherein the simulated artifact comprises a chest compression artifact or a ventilation artifact.

7. The computing device of claim 5, wherein the simulated artifact is indicative of an error in operation of a medical device, and
wherein the simulated medical device UI further indicates the error.

8. The computing device of claim 7, wherein the error is indicates a disconnected sensor, a motion artifact, or a misused sensor.

9. The computing device of claim 5, wherein the processor is further configured to:
generate the simulated artifact by analyzing the simulated patient data.

10. The computing device of claim 4, the patient data being first patient data, the subject being a first subject, the rescue event being a first rescue event, wherein the processor is configured to generate the simulated patient data by altering the first patient data by:
combining characteristics of the first patient data with characteristics of second patient data indicating physiological parameters of a second subject during a second rescue event.

11. The computing device of claim 10, wherein the processor is configured to generate the characteristics of the first patient data with characteristics of the second patient data by:
inputting, into a machine learning model configured to identify the characteristics of the first patient data and the characteristics of the second patient data, the first patient data and the second patient data; and
receiving, from the machine learning model, the simulated patient data.

12. The computing device of claim 10, wherein the characteristics of the first patient data and the characteristics of the second patient data are associated with the medical condition.

13. The computing device of claim 4, the input signal being a first input signal, wherein the input device is further configured to detect a second input signal from the user,
wherein the processor is further configured to modify a visual characteristic of the simulated medical device UI in response to the second input signal, and
wherein the computing device is further configured to output, to a medical device, an instruction to modify the visual characteristic of a medical device UI output by the medical device.

14. The computing device of claim 13, wherein the visual characteristic comprises a color, a text size, an icon size, or an icon orientation.

15. The computing device of claim 4, wherein the processor is further configured to:
generate a simulated event record comprising the simulated patient data and an indication of the input signal; and
cause the display to visually present the simulated event record.

16. A method performed by a computing device, the method comprising:
receiving patient data indicating physiological parameters of a subject during a rescue event;
generating simulated patient data by altering the patient data, the simulated patient data indicating physiological parameters of a simulated subject during a simulated rescue event;
generating a simulated medical device user interface (UI) indicating the simulated patient data;
receiving an input signal from a user;
displaying the simulated medical device UI by:
displaying a first segment of the simulated patient data indicating a medical condition that is responsive to a treatment;
displaying a recommendation to administer the treatment; and
in response to displaying the recommendation to administer the treatment and in response receiving the input signal, displaying a second segment of the simulated patient data indicating a simulated response to the treatment.

17. The method of claim 16, wherein generating the simulated patient data by altering the first patient data comprises:
injecting, into the patient data, a simulated artifact.

18. The method of claim 17, wherein the simulated artifact comprises a chest compression artifact or a ventilation artifact.

19. The method of claim 18, wherein the simulated artifact is indicative of an error in operation of a medical device, and
wherein the simulated medical device UI further indicates the error.

20. The method of claim 19, wherein the error is indicates a disconnected sensor, a motion artifact, or a misused sensor.
